(19) United States
(12) Patent Application Publication
(10) Pub. No.: US 2014/0138577 A1
(43) Pub. Date: May 22, 2014

(54) Method Of Forming Polysilanes And Polycarbosilanes In The Presence Of A Metal Silicide

(71) Applicants: Dimitris Elias Katsoulis, Midland, MI (US); Robert Thomas Larsen, Midland, MI (US)

(72) Inventors: Dimitris Elias Katsoulis, Midland, MI (US); Robert Thomas Larsen, Midland, MI (US)

(73) Assignee: Dow Corning Corporation, Midland, MI (US)

(21) Appl. No.: 14/126,251

(22) PCT Filed: Jun. 14, 2012
(86) PCT No.: PCT/US2012/042475

§ 371 Date: Jan. 29, 2014

Related U.S. Application Data
(60) Provisional application No. 61/497,577, filed on Jun. 16, 2011.

(51) Int. Cl. C08L 83/00

(52) U.S. Cl. CPC C08L 83/00
USPC 252/182.3

(57) ABSTRACT

A mixture of at least one polysilane and at least one polycarbosilane is formed in the presence of a metal silicide. The mixture is formed utilizing a method that includes the step of combining the metal silicide and an alkyl halide in a reactor at a temperature of from 200° C. to 600° C. The alkyl halide has the formula RX, wherein R is C₁-C₁₀ alkyl and X is halo. This method forms high yield mixtures of the at least one polysilane and the at least one polycarbosilane. Additionally, the mixture is time and cost effective and allows the mixture to be formed in a predictable and controlled manner. Moreover, the components used in this method can be easily recycled and/or re-used in other processes.

### CROSS REFERENCE TO RELATED APPLICATION

This application claims priority to and all the advantages of U.S. Provisional Patent Application No. 61/497,577 filed on Jun. 16, 2011, which is incorporated by reference herein in its entirety.

Polysilanes and polycarbosilanes are well known in the art and tend to have either an all silicon backbone —(Si—Si)— or a silicon-carbon backbone —(Si—C)—, respectively. Polysilanes are typically formed in a Wurtz coupling process using, as one example, Me₂SiCl₂, sodium or potassium metal, toluene, and heat. This process is time consuming, expensive, and difficult to implement on a production scale because metals such as sodium and potassium are pyrophoric, difficult to handle, and costly. In addition, this process generates inorganic salts as by-products which need to be disposed of and/or recycled, thereby further increasing production complexities and costs. Since scaling up this process to commercial production scale is not practical, the large scale production of polysilanes tends to be difficult and expensive.

Polycarbosilanes are typically formed using Grignard reactions of chloromethyltrichlorosilanes, ring-opening polymerization reactions of 1,3-disilacyclobutane derivatives, and/or hydrosilylation reactions of vinyl silanes. These reactions tend to be inefficient and expensive and tend to generate unwanted by-products that lower the yield of the polycarbosilanes. In addition, it is both costly and difficult to recycle the by-products and other remnants of these reactions. Accordingly, scaling up these reactions to commercial production scale is also not practical. Just as above, this difficulty in scaling makes the large scale production of polycarbosilanes difficult and expensive. As a result of the aforementioned production difficulties, there remains an opportunity to develop an improved process for forming both polysilanes and polycarbosilanes.

### SUMMARY OF THE DISCLOSURE

The instant disclosure provides a method of forming a mixture including at least one polysilane and at least one polycarbosilane in the presence of a metal silicide. The method includes the step of combining the metal silicide and an alkyl halide in a reactor at a temperature of from 200° C. to 600° C. to form the mixture. The alkyl halide has the formula RX, wherein R is C₁-C₁₀ alkyl and X is halo.

### DETAILED DESCRIPTION OF THE DISCLOSURE

The present disclosure provides a method of forming a mixture including at least one polysilane and at least one polycarbosilane. As is well known in the art, polysilanes typically have a backbone of silicon atoms bonded to each other (Si—Si bonds) while polycarbosilanes typically have a backbone of silicon atoms bonded to carbon atoms (Si—C—Si bonds). Illustrative, but non-limiting, examples of typical polysilanes and polycarbosilanes are set forth immediately below:

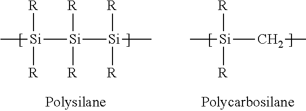

In the aforementioned structures, “R” is merely shown as a placeholder, is non-limiting, and does not represent any particular atom or compound. Other non-limiting examples are similar to those above and include pendant silicon atoms bonded to backbone carbon atoms, pendant carbon atoms bonded to backbone silicon atoms, and/or pendant silicon atoms bonded to backbone silicon atoms. Each of the at least one polysilane and the at least one polycarbosilane may be linear, branched, or cyclic. In other words, the mixture of the at least one polysilane and the at least one polycarbosilane may include one or more linear, branched, or cyclic polysilanes and one or more linear, branched, or cyclic polycarbosilanes. In addition, there can be both Si—C—Si and Si—Si bonds in the same molecular, e.g. a mixed polysilane/polycarbosilane molecule.

### Polysilanes:

In one embodiment, the mixture includes at least one polysilane that has the formula R₃Si—(R₂Si)ₘ—SiR₃ wherein each R may be the same or different from one another and each R is independently a C₁-C₂₀, C₁-C₁₀, and/or a C₁-C₄ alkyl, aryl, alkaryl or aralkyl (group) and where m has a value of from 1 to 100. Alternatively, it is contemplated that one or more R groups may be —H, i.e., a hydrogen atom. In addition, it is contemplated that R can be a halogen atom, such as Cl. In alternative embodiments, m has an average value of from 1 to 15, from 2 to 14, from 3 to 13, from 4 to 14, from 5 to 13, from 6 to 12, from 7 to 11, from 8 to 10, from 9 to 10, from 1 to 5, from 1 to 4, from 1 to 3, from 1 to 2, from 2 to 5, from 2 to 3, from 2 to 4, from 3 to 5, or from 3 to 4. The mixture may also include a disilane where m=0. Of course, the disclosure is not limited to these particular values of m and the value of m may be any value or range of values, both whole and fractional, within those ranges and values described above.

At least one polysilane may be branched. Although not particularly limited, the branched polysilane typically has only one silicon side chain per molecule but may have two or more. In still another embodiment, at least one polysilane is cyclic. Typically, the cyclic polysilane has from 4 to 12, from 4 to 10, or from 4 to 8, silicon atoms. It is also contemplated that the mixture may include at least two polysilanes and at least one of the polysilanes may be branched and/or at least one of the polysilanes may be cyclic.

### Polycarbosilanes:

At least one polycarbosilane may have the formula R²₃S₁—CH₂(R²₂Si—CH₂)ₙ—SiR²₃ wherein each R² may independently be the same or different than R above and n may be the same or different from m above. It is to be understood that, in the same mixture, each of R and R² and m and n can differ from each other in each polysilane and polycarbosilane. In one embodiment, the mixture includes a carbodisilane wherein n=0. In another embodiment, at least one polycarbosilane is branched. Although not particularly limited, the branched polycarbosilane typically has only one side chain per molecule but may have two or more. In still another embodiment, at least one polycarbosilane is cyclic. Typically, the cyclic polycarbosilane has from 2 to 4 or 2 to 3 silicon atoms. These cyclic polycarbosilanes are not particularly limited and one or more may be selected from the group of 1,1,3,3-tetramethyl-1,3 disilacyclobutane, 1,1,3,3,-tetramethyl-1,3-disilacyclopentane, 1,1,3,3,5-pentamethyl-1,3,5-trisilacylohexane, 1,1,3,3,5,5-hexamethyl-1,3,5-trisilacylohexane, and combinations thereof. Alternatively, the mixture may include at least two polycarbosilanes and at least one of the polycarbosilanes may be branched and/or at least one of the polycarbosilanes may be cyclic.

The mixture may alternatively include at least two polysilanes and at least two polycarbosilanes wherein at least one of the polysilanes and/or at least one of the polycarbosilanes is cyclic. In another embodiment, the mixture includes at least two polysilanes and at least two polycarbosilanes wherein at least one of the polysilanes and/or at least one of the polycarbosilanes is branched.

### Additional Polysilanes/Polycarbosilanes

It is also contemplated that the mixture may include one or more mixed or hybrid polysilane-polycarbosilanes. Mixed or hybrid polysilane-polycarbosilanes include both Si—Si bonds and Si—C bonds in the backbone. Typically, mixed or hybrid polysilane-polycarbosilanes include polysilane portions or blocks and polycarbosilane portions or blocks, as shown strictly for illustrative purposes below wherein m and/or n may independently be the same or different from m and/or n described above and each R³ is independently chosen and may be the same or different from R and R² described above:

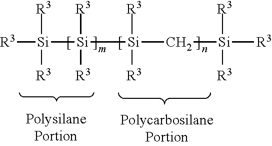

It is also contemplated that the mixture may include one or more compounds of the following formulas: X₃Si—(X₂Si—SiX₂)ₐ—SiX₃ and X′₃Si—CH₂—(X′₂Si—CH₂)_{b}—StX′₃, wherein 0≦a, b<20, and each of X and X′ is independently Cl, H or Me. It is also contemplated that each of X and X′ may independently be C₁-C₁₀ or C₁-C₄ or halo. In various embodiments, at the beginning of the reaction to form the mixture, X has a tendency to be Me or H. Then, at the end of the reaction, X has a tendency to be Cl more often. In other embodiments, branched analogues of the aforementioned compounds and/or compounds of the following formula: Me₃Si—Me₂S₁—CH₂—SiMe₃, are included in the mixture.

In still other embodiments, the mixture includes one or more halopolysilanes and/or one or more halopolycarbosilanes. The halo atoms of these compounds are not particularly limited and may include fluoro, chloro, bromo, and/or iodo atoms. In various other embodiments, the mixture also includes one or more silicon monomer(s) selected from the group of SiH₄, Me₄Si, Me₃SiH, Me₃SiCl, Me₂SiCl₂, Me₂HSiCl, MeSiCl₃, MeHSiCl₂, SiCl₄, EtSiCl₃, n-PrSiCl₃, Allyl-SiCl₃, silacyclobutane, Me₂EtSiCl, MeEtSiCl₂, t-BuMe₂SiCl, Me₃SiCH₂CCCH₃, and combinations thereof.

In still other embodiments, one or more cyclic or branched species such as those described immediately below may be present in the mixture:

(CH₂SiR₂)_{f} wherein each R is independently Cl, Me, Et, H; f>3;
(CH₂SiR₂)_{f}(OSiR₂), wherein each R is independently chosen from Cl, Me, Et, H; (f+e)>3;
(SiR₂)_{f} wherein each R is independently Cl, Me, Et, H; f>3
(SiR₂)_{f}(CH₂SiR₂), wherein each R is independently Cl, Me, Et, H; (f+e)>3;
R₂Si(CR₂)₃ wherein each R is independently Cl, Me, Et, H;
R₃Si(SiR₂)_{f}[SiR(SiR₃)](SiR₂)ₑSiR₃ wherein each R is independently chosen from Cl, Me, Et, H; f>0, e>0;
R₃Si(SiR₂)_{f}[SiR(CH₂SiR₃)](SiR₂)ₑSiR₃ wherein each R is independently chosen from Cl, Me, Et, H; f>0, e>0;
R₃Si(CH₂SiR₂)_{f}[CH₂SiR(SiR₃)](CH₂SiR₂)ₑCH₂SiR₃ wherein each R is independently chosen from Cl, Me, Et, H; f>0, e>0;
R₃Si(CH₂SiR₂)_{f}[CH(SiR₃)SiR₂](CH₂SiR₂)ₑCH₂SiR₃ wherein each R is independently chosen from Cl, Me, Et, H; f>0, e>0;
R₃Si(CH₂SiR₂)_{f}[CH(R)SiR₂](CH₂SiR₂)ₑCH₂SiR₃ wherein each R is independently chosen from Cl, Me, Et, H; f>0, e>0;
R₃Si(CH₂SiR₂)_{f}[CH₂SiR(CH₂SiR₃)](CH₂SiR₂)ₑCH₂SiR₃ wherein each R is independently chosen from Cl, Me, Et, H; f>0, e>0;
(R₃Si)₃CH wherein each R is independently chosen from Cl, Me, Et, H;
(R₃Si)₃C—CH₃ wherein each R is independently chosen from Cl, Me, Et, H;
(R₃Si)₂C═CH₂ wherein each R is independently chosen from Cl, Me, Et, H;
R₃Si(CH₂SiR₂)_{g}(SiR₂)ₕ[SiR(SiR₃)](SiR₂)ₑ(CH₂SiR₂)_{f} SiR₃ wherein each R is independently chosen from Cl, Me, Et, H; g>0, h>0, f>0, e>0;
R₃Si(CH₂SiR₂)_{g}(SiR₂)ₕ[SiR(CH₂SiR₃)](SiR₂)ₑ(CH₂SiR₂)_{f} SiR₃ wherein each R is independently chosen from Cl, Me, Et, H; g>0, h>0, f>0, e>0;
R₃Si(SiR₂)_{g}(CH₂SiR₂)ₕ[CH₂SiR(SiR₃)](CH₂SiR₂)ₑ(SiR₂)_{f} CH₂SiR₃ wherein each R is independently chosen from Cl, Me, Et, H; g>0, h>0, f>0, e>0;
R₃Si(SiR₂)_{g}(CH₂SiR₂)ₕ[CH(SiR₃)SiR₂](CH₂SiR₂)ₑ(SiR₂)_{f} CH₂SiR₃ wherein each R is independently chosen from Cl, Me, Et, H; g>0, h>0, f>0, e>0;
R₃Si(SiR₂)_{g}(CH₂SiR₂)ₕ[CH(R)SiR₂] (CH₂SiR₂)ₑ(SiR₂)_{f}CH₂SiR₃ wherein each R is independently chosen from Cl, Me, Et, H; g>0, h>0, f>0, e>0; and
R₃Si(CH₂SiR₂)_{f}[CH₂SiR(CH₂SiR₃)] (CH₂SiR₂)ₑ(SiR₂)_{f}CH₂SiR₃ wherein each R is independently chosen from Cl, Me, Et, H; f>0, e>0.
Additional multiple branched, longer chain branched, and/or more complex mixed carbosilane/polysilane compounds may also be included in the mixture.

Additional compounds may also be formed by the method of this disclosure. These compounds include, but are not limited to, straight chain polysilanes, straight chain carbosilanes, and mixed carbo/polysilanes. Suitable but non-limiting examples of straight chain polysilanes have the formula R₃Si(SiR₂)_{f}SiR₃ wherein f>0 and each R is independently H, Methyl (or other hydrocarbon), or Cl (or other halogen). Suitable but non-limiting examples of straight chain carbosilanes have the formula R₃SiCH₂(SiR₂CH₂)_{f}SiR₃ wherein f>0 and each R is independently from H, Methyl (or other hydrocarbon), or Cl (or other halogen). Suitable but non-limiting examples of mixed carbo/polysilanes have one or more of the following formulae: R₃SiCH₂(SiR₂CH₂)ₑ(SiR₂)_{f}SiR₃ (e>0, f>0); R₃Si(SiR₂CH₂)ₑ(SiR₂)_{f}SiR₃ (e>0, f>0); R₃SiCH₂(SiR₂)ₘ(SiR₂CH₂)ₙSiR₃ (e>0, f>0); R₃SiCH₂(SiR₂)_{g}(SiR₂CH₂)ₑ(SiR₂)_{f}SiR₃ (g, e, f>0); R₃SiCH₂(SiR₂CH₂)_{g}(SiR₂)ₑ(SiR₂CH₂)ₕSiR₃ (g, e, f>0); R₃Si(SiR₂)_{g}(SiR₂CH₂)ₑ(SiR₂)_{b}SiR₃ (g, e, f>0); and R₃Si(SiR₂CH₂)_{g}(SiR₂)ₑ(SiR₂CH₂)_{f}SiR₃ (g, e, f>0), wherein for each of the aforementioned formulae, each R is independently H, Methyl (or other hydrocarbon), or Cl (or other halogen). Additional more complex mixed carbo/polysilanes including groups similar to g, e and f are also contemplated herein.

The mixture is not particularly limited relative to amounts of the at least one polysilane and the at least one polycarbosilane. It is contemplated that the at least one polysilane may be present in the mixture in amounts of from 1 to 99, from 5 to 95, from 10 to 90, from 15 to 85, from 20 to 80, from 25 to 75, from 30 to 70, from 35 to 65, from 40 to 60, from 45 to 55, or from 45 to 50, weight percent based on a total weight of the mixture. The at least one polycarbosilane may be present in the same or similar amounts. In one embodiment, the at least one polysilane and the at least one polycarbosilane are each present in amounts of about 50 weight percent based on a total weight of the mixture. Additionally, the one or more mixed or hybrid polysilane-polycarbosilanes may be present in the mixture in amounts of from 0.1 to 20, of from 0.1 to 10, or of from 0.1 to 5, weight percent based on a total weight of the mixture. The one or more halopolysilanes and/or one or more halopolycarbosilanes may be present in the mixture in amounts of from 0.1 to 20, of from 0.1 to 10, or of from 0.1 to 5, weight percent based on a total weight of the mixture. The one or more silicon monomer(s) may be present in the mixture in amount of from 0.1 to 99, from 0.5 to 50, from 1 to 50, from 5 to 50, or from 5 to 25, weight percent based on a total weight of the mixture. The disclosure is not limited to any of the aforementioned values and any one or more of those values may be further defined as a particular value or range of particular values, both whole and fractional, within those ranges described above.

Alternatively, the mixture may consist of, or consist essentially of, the at least one polysilane and the at least one polycarbosilane. It is also contemplated that the mixture may consist of or consist essentially of the at least one polysilane and the at least one polycarbosilane in addition to one or more of the mixed or hybrid polysilane-polyc arbosilanes, silicon monomer(s), halopolysilanes and/or halopolycarbosilanes. In various embodiments wherein the mixture consists essentially of the at least one polysilane and the at least one polycarbosilane, the mixture is free of, or includes less than 10, 5, or 1, weight percent of other chlorinated (or halogenated) organic solvents such as CCl₄, SiH₄, other silanes, monomethyltrichlorosilane, and/or any of the silicon monomers described above, and/or combinations thereof, based on a total weight of the mixture. It is also contemplated that the mixture consisting essentially of the polysilane and the polycarbosilane may include the silicon monomer(s) or may be free of the silicon monomer(s). It is further contemplated that the aforementioned description of weight percents may apply to embodiments wherein the mixture consists essentially of the at least one polysilane and the at least one polycarbosilane in addition to one or more of the mixed or hybrid polysilane-polycarbosilanes, silicon monomer(s), halopolysilanes and/or halopolycarbosilanes. In other embodiments, the terminology “consisting essentially of” describes the mixture being free of compounds, known to those of skill in the art, that materially affect the overall composition of the mixture.

### Method of Forming the Mixture:

Referring back to the method itself, the method includes the step of combining a metal silicide and an alkyl halide in a reactor at a temperature of from 200° C. to 600° C. to form the mixture. The metal silicide is typically further defined as Mg₂Si but is not limited to this compound. It is contemplated that the metal silicide may be further defined as a Group I, Group II, or transition metal silicide. Alternatively, more than one silicide and/or mixed silicides can be utilized. The metal silicide is typically a solid and may have a particle size of about 1 in, ⅞ in., ¾ in., ⅝ in., 0.530 in., ½ in., 7/16 in., ⅜ in., 5/16 in., 0.265 in., or ¼ in., or a mesh size of Nos. 3.5, 4-8, 10, 12, 14, 16, 18, 20, 25, 30, 35, 40, 45, 50, 60, 70, 80, 100, 120, 140, 170, 200, 230, 270, 325, 400, etc, mesh. The disclosure is not limited to any of the aforementioned particular values or ranges of values and the particle size may be any value or range of values, both whole and fractional, within those ranges and values described above.

The alkyl halide has the formula RX, wherein R is C₁-C₁₀ alkyl and X is halo, i.e., a halogen atom. It is also contemplated that R may be C₁-C₄ alkyl. The C₁-C₁₀ (or C₁-C₄)alkyl is not particularly limited and any alkyl group having 1, 2, 3, 4, 5, 6, 7, 8, 9, or 10 carbon atoms may be utilized including isomers thereof. Similarly, any halo atom can be used. Typically, the alkyl halide is further defined as MeCl and/or propyl chloride. It is also contemplated that mixtures of alkyl halides can be used so long as at least one alkyl halide of the mixture is of the aforementioned formula. In other words, the mixture of alkyl halides can include one or more alkyl halides that differ from the aforementioned formula so long as at least one alkyl halide of the aforementioned formula is utilized.

In one embodiment, the method includes the step of combining Mg₂Si (i.e., the metal silicide) and the alkyl halide in a reactor at a temperature of from 200° C. to 600° C. to form the mixture. Typically, the formation of stable salts drive the formation of the mixture including the at least one polysilane and the at least one polycarbosilane. The step of combining may be further defined as reacting the Mg₂Si and the alkyl halide. The Mg₂Si and the alkyl halide are typically reacted in approximately equal molar ratios but the amounts of each are not particularly limited. In one embodiment, the alkyl halide is passed over the Mg₂Si in a flow reactor until no additional reaction occurs or until undesired selectively of products begins. Typically, once all of the silicon is reacted and/or all of the Mg is reacted (to form, for example, MgCl₂ by taking up chlorine) then the reaction will cease.

The metal silicide (e.g. the Mg₂Si) and the alkyl halide react in a reactor in a continuous, semi-continuous, or batch mode. Most typically, the reactor is a continuous reactor. The particular type of reactor is not limited and may be further defined as a fluidized bed reactor, a gas phase heterogeneous reactor, a fixed bed reactor, etc. The length and size of the reactor are also not particularly limited. Typically, the length and volume of the reactor is sufficient to achieve adequate residence time of contact of the alkyl halide with the silicide. Typical, but non-limiting, residence times are from 0.1 to 100, from 0.1 to 30, from 0.5 to 20, or from 1 to 10, seconds. As appreciated by those of skill in the art, the terminology “residence time” describes an average amount of time the alkyl halide spends in the reactor before exiting such that it contacts the silicide.

In one embodiment, the metal silicide (e.g. the Mg₂Si) is stationary and the alkyl halide is passed through and/or over the Mg₂Si. In this embodiment, the alkyl halide has a residence time in or over the metal silicide of from 0.1 to 10, from 0.5 to 10, from 0.5 to 9.5, from 1 to 8.5, from 1.5 to 8, from 2 to 7.5, from 3 to 7, from 3.5 to 6.5, from 4 to 6, from 4.5 to 5.5, or of about 5, seconds. It is contemplated that these residence times may be increased or decreased appropriately depending on the size of the reactor, the conditions of reaction, and the desired products. It is to be understood that an increase in reactor size does not necessarily increase residence time. In fact, an increase in reactor size may decrease residence time. The alkyl halide and the metal silicide typically react for a total time of from minutes to hours. In other words, the entire reaction (and not any one particular residence time) typically occurs for a time of from minutes to hours. In various embodiments, the metal silicide and the alkyl halide react for a time of from 1 to 60 minutes, from 1 to 40 minutes, from 1 to 20 minutes, from 1 to 24 hours, from 1 to 15 hours, from 1 to 10 hours, from 1 to 5 hours, etc. In addition, the reactor temperature is not particularly limited within the aforementioned range and may be further defined as from 210 to 590, from 220 to 580, from 230 to 570, from 240 to 560, from 250 to 550, from 260 to 540, from 270 to 530, from 280 to 520, from 290 to 510, from 300 to 500, from 310 to 490, from 320 to 480, from 330 to 470, from 340 to 460, from 350 to 450, from 360 to 440, from 370 to 430, from 380 to 420, from 390 to 410, of from 325 to 500, or of about 400, ° C. Temperatures above 600° C. tend to cause decomposition of alkyl halides. Temperatures less than 200° C. tend to be ineffective in promoting reaction. The metal silicide and the alkyl halide also typically react at atmospheric pressure or higher but this disclosure is not limited to any particular pressure. In various embodiments, the pressure is further defined as 0.5, 1, 1.5, 2, 2.5, 3, 3.5, 4, 4.5, 5, or 5+, atmospheres. The metal silicide and the alkyl halide react to form the mixture having yields of the at least one polysilane and/or the at least one polysilane of at least 30, 35, 40, 45, 50, 55, 60, 65, 70, 75, 80, 85, 90, 95, or 95+, percent yield. The disclosure is not limited to any of the aforementioned values and any one or more of those values may be further defined as a particular value or range of particular values, both whole and fractional, within those ranges described above.

In additional embodiments, the method is further defined as a method of forming the mixture includes at least one linear polysilane, at least one linear polycarbosilane, and at least one cyclic polycarbosilane in the presence of Mg₂Si wherein the method includes the step of combining the Mg₂Si and methyl chloride in a continuous fluidized bed reactor at a temperature of from 200° C. to 600° C. to form the mixture. In this embodiment, at least one polysilane has the formula X₃Si—(X₂Si—SiX₂)ₐ—SiX₃ and at least one polycarbosilane has the formula X′₃S₁—CH₂—(X′₂Si—CH₂)_{b}—SiX′₃, wherein 0≦a, b<20, and each of X and X′ is independently Cl, H or Me. In another embodiment, X of the at least one polysilane is further defined as methyl. In still another embodiment, the mixture includes at least one additional polycarbosilane that is selected from the group of 1,1,3,3-tetramethyl-1,3disilacyclobutane, 1,1,3,3,-tetramethyl-1,3-disilacyclopentane, 1,1,3,3,5-pentamethyl-1,3,5-trisilacylohexane, 1,1,3,3,5,5-hexamethyl-1,3,5-trisilacylohexane, and combinations thereof. In a further embodiment, the mixture further includes at least one silicon monomer selected from the group of Me₄Si, Me₃SiH, Me₃SiCl, Me₂SiCl₂, Me₂HSiCl, MeSiCl₃, MeHSiCl₂, SiCl₄, EtSiCl₃, n-PrSiCl₃, Allyl-SiCl₃, silacyclobutane, Me₂EtSiCl, MeEtSiCl₂, t-BuMe₂SiCl, Me₃SiCH₂CCCH₃, and combinations thereof.

The method of this disclosure tends to form high yield mixtures of the at least one polysilane and the at least one polycarbosilane. Additionally, the method of preparing the mixture is time and cost effective and allows the mixture to be formed in a predictable and controlled manner. Moreover, the components used in this method can be easily recycled and/or re-used in other processes. Furthermore, this method tends to increase industrial safety, tends to minimize production complexities (e.g. can utilize fluid or vibrating beds), and allows for customization/tuning of selectivity of which polysilanes and polycarbosilanes are formed by manipulating silicide content, residence time, chloride content, etc.

### EXAMPLES

A mixture of the instant disclosure was formed along with comparative mixtures that are not representative of this disclosure. These mixtures were then analyzed to determine content of at least one polysilane and at least one polycarbosilane.

### Example 1

### Formation of One Embodiment of the Instant Disclosure

To form the mixture, Mg₂Si (Sigma Aldrich, 99+%) and 0.32 g of Mg₂Si (i.e., a Group II metal silicide) was loaded into a quartz glass tube inside of an inert glove box. The quartz tube was then inserted into a flow reactor, and during the insertion, the Mg₂Si was briefly exposed to atmospheric (i.e., non-dry) air (10-20 seconds maximum). The reactor was then quickly purged with H₂ to remove any remaining atmospheric air. Activation of the Mg₂Si was then performed with 100 sccm H₂ (controlled via Omega FMA 5500 mass flow controller) at 500° C. (heated in a Lindberg/Blue Minimite 1″ tube furnace). Afterwards, the temperature of the reactor was reduced to 400° C., the H₂ flow was shut off and a flow of 50 sccm of Ar was utilized for 30 minutes to purge the reactor of all H₂.

After purging with Ar, the reaction was started by shutting off the Ar and flowing MeCl (i.e., a Cl alkyl halide) through the reactor at a rate of 5 sccm. The reaction was then periodically sampled over 60 min by GC/GC-MS to monitor the amounts of various reaction products that were formed. The effluent of the reactor passed through an actuated 6-way valve (Vici) with constant 100 μL injection loop before being discarded. Samples were taken from the reaction stream by actuating an injection valve and a 100 μL sample was passed directly into the injection port of a 7890A Agilent GC-MS for analysis with a split ratio at the injection port of 100:1. The GC included two 30 m SPB-Octyl columns (Supelco, 250 μm inner diameter, 0.25 um thick film) which were placed in parallel such that the sample was split evenly between the two columns One column was connected to a TCD detector for quantification of the reaction products and the other column was connected to a mass spectrometer (Agilent 7895C MSD) for sensitive detection of trace products and positive identification of any products that formed. Rather than being heated in a GC oven, the columns were heated by an Agilent LTM module, i.e., the columns were wrapped with heating elements and thermocouples such that they were precisely and rapidly ramped to the desired temperature. This low thermal mass system allowed rapid analysis (as little as 7 minutes between sample injections). All steps were performed at atmospheric pressure.

The mixture formed using the aforementioned procedure included numerous linear oligomeric polysilanes and polycarbosilanes of the formulas X₃Si—(X₂Si—SiX₂)ₐ—SiX₃ and X′₃S₁—CH₂—(X′₂S₁—CH₂)_{b}—SiX′₃, where 0≦a, b<20, and each of X and X′ are independently Cl, H or Me. At the beginning of the reaction, X had a tendency to be Me or H. Then, at the end of the reaction, X had a tendency of be Cl more often. In this mixture, mixed polysilane/carbosilanes including some of the formula Me₃Si-Me₂S₁—CH₂—SiMe₃ were also included. The mixture also included cyclic carbosilanes including 1,1,3,3-tetramethyl-1,3disilacyclobutane; 1,1,3,3,-tetramethyl-1,3-disilacyclopentane; 1,1,3,3,5-pentamethyl-1,3,5-trisilacylohexane; and 1,1,3,3,5,5-hexamethyl-1,3,5-trisilacylohexane. In addition, the mixture included various Si monomers including Me₄Si, Me₃SiH, Me₃SiCl, Me₂SiCl₂, Me₂HSiCl, MeSiCl₃, MeHSiCl₂, SiCl₄, EtSiCl₃, n-PrSiCl₃, Allyl-SiCl₃, silacyclobutane, Me₂EtSiCl, MeEtSiCl₂, t-BuMe₂SiCl, and Me₃SiCH₂CCCH₃. In sum, the mixture included about 10 to 30 weight percent of polysilanes based on a total weight of the mixture and about 10 to 30 weight percent of polycarbosilanes based on a total weight of the mixture, representing 5 to 50 percent yields, respectively.

### Comparative Example 1A

Comparative Example 1A was formed using the same procedure described above except that the alkyl halide (MeCl) was replaced with PhCl, which is not an alkyl halide of this disclosure, and the reactor temperature was 200° C. Comparative Example 1A did not form significant quantities of polysilanes or polycarbosilanes.

### Comparative Example 1B

Comparative Example 1B was formed using the same procedure described above except that the alkyl halide (MeCl) was replaced with PhCl, which is not an alkyl halide of this disclosure, and the reactor temperature was 500° C. Comparative Example 1B did not form significant quantities of polysilanes or polycarbosilanes.

### Comparative Example 2A

Comparative Example 2A was formed using the same procedure described above except that the alkyl halide (MeCl) was replaced with HCl, which is not an alkyl halide, and the reactor temperature was 200° C. Comparative Example 2A produced a mixture that includes trace amounts of SiH₄, HSiCl₃, and SiCl₄, none of which are polysilanes or polycarbosilanes.

### Comparative Example 2B

Comparative Example 2B was formed using the same procedure described above except that the alkyl halide (MeCl) was replaced with HCl, which is not an alkyl halide, and the reactor temperature was 500° C. Comparative Example 2B still produced a mixture that included trace amounts of SiH₄, HSiCl₃, and SiCl₄, none of which are polysilanes or polycarbosilanes.

### Comparative Example 3A

Comparative Example 3A was formed using the same procedure described above except that the alkyl halide (MeCl) was replaced with PrSiCl₃, which is not an alkyl halide of this disclosure, and the reactor temperature was 200° C. Comparative Example 3A produced a mixture that included trace amounts of PrSiH₃, PrSiHCl₂, SiCl₄, and Allyl-SiCl₃, none of which are polysilanes or polycarbosilanes.

### Comparative Example 3B

Comparative Example 3B was formed using the same procedure described above except that the alkyl halide (MeCl) was replaced with PrSiCl₃, which is not an alkyl halide of this disclosure, and the reactor temperature was 500° C. Comparative Example 3B still produced a mixture that included trace amounts of PrSiH₃, PrSiHCl₂, SiCl₄, and Allyl-SiCl₃, none of which are polysilanes or polycarbosilanes.

The aforementioned results demonstrate that the instant disclosure produces results that are both superior to, and unexpected, over the comparative examples. More specifically, these results demonstrate that this disclosure produces polysilanes and polycarbosilanes in high yield using a method that is time and cost effective and that allows the mixture to be formed in a predictable and controlled manner. Moreover, the components used in this method can be easily recycled and/or re-used in other processes.

It is to be understood that one or more of the values described above may vary by ±5%, ±10%, ±15%, ±20%, ±25%, ±30%, etc. so long as the variance remains within the scope of the disclosure. It is also to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The subject matter of all combinations of independent and dependent claims, both singly and multiply dependent, is herein expressly contemplated but is not described in detail for the sake of brevity. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A method of forming a mixture comprising at least one polysilane and at least one polycarbosilane in the presence of a metal silicide, said method comprising the step of combining the metal silicide and an alkyl halide in a reactor at a temperature of from 200° C. to 600° C. to form the mixture wherein the alkyl halide has the formula RX, wherein R is C₁-C₁₀ alkyl and wherein X is halo.

2. A method as set forth in claim 1 wherein the metal silicide comprises a Group I or Group II metal.

3. A method as set forth in claim 2 wherein the metal silicide is further defined as Mg₂Si.

4. A method as set forth in claim 1 wherein X is chloro.

5. A method as set forth in claim 1 wherein R is further defined as methyl.

6. A method as set forth in claim 1 wherein at least one polysilane has the formula R₃Si(R₂Si)ₘSiR₃ wherein each R is independently C₁-C₄ alkyl, halo, or H, and m has an average value of from 1 to 5.

7. A method as set forth in claim 6 wherein the at least one polysilane is linear.

8. A method as set forth in claim 1 wherein the mixture comprises at least two polysilanes and at least one of the polysilanes is branched.

9. A method as set forth in claim 1 wherein the mixture comprises at least two polysilanes and at least one of the polysilanes is cyclic.

10. A method as set forth in claim 1 wherein at least one polycarbosilane has the formula R²₃S₁—CH₂(R²₂S₁—CH₂)ₙSiR²₃ wherein each R² is independently C₁-C₄ alkyl, halo, or H, and n has an average value of from 1 to 5.

11. A method as set forth in claim 10 wherein the at least one polycarbosilane is linear.

12. A method as set forth in claim 1 wherein the mixture further comprises at least one hybrid polysilane-carbopolysilane having the formula R₃³Si—[SiR³₂]ₘ[SiR³₂CH₂]SiR³₃ wherein each R³ is independently C₁-C₄ alkyl, halo, or —H, m has a value of 1 to 5 and n has an average value of from 1 to 5.

13. A method as set forth in claim 1 wherein the mixture comprises at least two polycarbosilanes and at least one of the polycarbosilanes is branched.

14. A method as set forth in claim 1 wherein the mixture comprises at least two polycarbosilanes and at least one of the polycarbosilanes is cyclic.

15. A method as set forth in claim 14 wherein the cyclic polycarbosilane is selected from the group of 1,1,3,3-tetramethyl-1,3disilacyclobutane, 1,1,3,3,-tetramethyl-1,3-disilacyclopentane, 1,1,3,3,5-pentamethyl-1,3,5-trisilacylohexane, 1,1,3,3,5,5-hexamethyl-1,3,5-trisilacylohexane, and combinations thereof.

16. A method as set forth in claim 1 wherein the mixture further comprises at least one silicon monomer selected from the group of Me₄Si, Me₃SiH, Me₃SiCl, Me₂SiCl₂, Me₂HSiCl, MeSiCl₃, MeHSiCl₂, SiCl₄, EtSiCl₃, n-PrSiCl₃, Allyl-SiCl₃, silacyclobutane, Me₂EtSiCl, MeEtSiCl₂, t-BuMe₂SiCl, Me₃SiCH₂CCCH₃, and combinations thereof.

17. A method as set forth in claim 1 wherein the process is further defined as continuous and the reactor is further defined as a fluidized bed reactor.

18. A method as set forth in claim 1 wherein the reactor temperature is further defined as from 325° C. to 500° C.

19. A method as set forth in claim 1 wherein the metal silicide and the alkyl halide react in the reactor at a pressure that exceeds atmospheric pressure.

20. A mixture comprising the at least one polysilane and the at least one polycarbosilane formed from the method set forth in claim 1.

21. A method of forming a mixture comprising at least one linear polysilane, at least one linear polycarbosilane, and at least one cyclic polycarbosilane in the presence of Mg₂Si, said method comprising the step of combining the Mg₂Si and methyl chloride in a continuous fluidized bed reactor at a temperature of from 200° C. to 600° C. to form the mixture,
wherein at least one polysilane has the formula X₃Si—(X₂Si—SiX₂)ₐ—SiX₃,
wherein at least one polycarbosilane has the formula X′₃S₁—CH₂—(X′₂S₁—CH₂)_{b}—SiX′₃, and
wherein 0≦a, b<20, and each of X and X′ is independently Cl, H or Me.

22-24. (canceled)

25. A mixture comprising the at least one linear polysilane and the at least one linear polycarbosilane formed from the method set forth in claim 21.
